(19) United States
(12) Patent Application Publication
(10) Pub. No.: US 2008/0251751 A1
(43) Pub. Date: Oct. 16, 2008

(54) Silicone surfactant compositions and use thereof for generating foam

(75) Inventors: Arndt Bruckner, Muiheim a.d. Ruhr (DE); Dirk Kuppert, Recklinghausen (DE)

Correspondence Address: FROMMER LAWRENCE & HAUG, 745 FIFTH AVENUE- 10TH FL., NEW YORK, NY, 10151, US

(73) Assignee: Evonik Goldschmidt, Essen (DE)

(21) Appl. No.: 12/099,889

(22) Filed: Apr. 9, 2008

(30) Foreign Application Priority Data
Apr. 10, 2007 (DE) 10 2007 016 966.5

(51) Int. Cl. A62D 1/04

(52) U.S. Cl. 252/3

(57) ABSTRACT

The present invention relates to compositions having organosilicon compounds for generating foams, where the organosilicon compounds have sulphonate groups and Si—O—C linkages, and also to the use of these compositions for producing aqueous foams, in particular fire-extinguishing foams and cleaning foams.

This application claims benefit under 35 U.S.C. 119(a) of German patent application DE 10 2007 016 966.5 on 10 Apr. 2007.

Any foregoing applications, including German patent application DE 10 2007 016 966.5, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to the use of organosilicon compounds containing sulphonate groups for generating aqueous foam which can be used on hydrophobic liquids, and to foam-forming substance compositions according to the invention.

Aqueous foams are suitable for diverse application purposes, for example in the field of cosmetics for producing shaving foam or skincare compositions, in the domestic or industrial sector for cleaning purposes, for suppressing dust formation, for papermaking, for dyeing processes, for the fractionation or separation of metals or salts thereof, for insulating ice surfaces, for the manufacture of concrete and cement, for protecting surfaces, buildings or vegetation against fire and/or heat, for fighting fire, including fires in mines, and for frost protection of plants. For a more detailed explanation of some of these applications, reference may be made to A. R. Aidun, C. S. Grove Jr., D. N. Meldrum, Novel Uses of Aqueous Foams, Chem. Eng. 1964, 71, 145-148. Moreover, there is a need for foams for applications in which the foam comes into contact with nonaqueous liquids, such as, for example, organic solvents or petrochemical fuels energy fuels (and engine fuels), and in which the foam has to have adequate stability and flowability. These applications include, inter alia, the cleaning of installations such as oil depots, pipes, pipelines or drums, the reduction in evaporative losses of volatile hydrocarbons or other organic solvents or fire-fighting. Thus, it is known to fight fires, in particular of fuels, by applying continuous layers of foam. Such layers of foam are also suitable for preventing fires from breaking out. For generating these foams, use is usually made of foam compositions which form a water-containing film between foam and combustible liquid (“Aqueous Film Forming Foam”—AFFF or A3F). This film ensures rapid spreading of the foam and provides a vapour-tight barrier and thus prevents reignition. As an essential constituent, AFFF comprise surfactants having perfluorinated groups. Foam compositions of this type are described, for example, in the specifications DE-12 16 116 (U.S. Pat. No. 3,258,423 A), EP-A-0 595 772 (U.S. Pat. No. 5,496,475 A), U.S. Pat. No. 4,420,434, DE-23 57 281.

DE-22 40 263 claims foam-forming substance compositions which consist of
a) a foaming agent, which, for example, may be a long-chain polysiloxane with attached sulphate groups,
b) an S— or O-(lower alkyl)-substituted oxy acid of sulphur or a salt thereof, and unconditionally
c) a surface-active agent of tetrafluoromethane.

DE-18 12 531 (U.S. Pat. No. 3,655,555) discloses that water-soluble polysiloxanes can be used as solubilizers for organic fluorine compounds for generating aqueous fire-extinguishing foam concentrates.

U.S. Pat. No. 3,849,315, U.S. Pat. No. 4,038,195, U.S. Pat. No. 3,957,657 and U.S. Pat. No. 3,957,658 disclose extinguishing foam mixtures comprising silicone surfactants which require the presence of surfactants with perfluorinated groups. The mixtures of surfactants with perfluorinated groups and silicone surfactant are themselves not adequately foaming and therefore have to be improved in terms of their foaming ability by adding surfactants which contain neither perfluorinated groups nor silicon atoms. In contrast to the compounds according to the invention, the described silicone surfactants are purely Si—C-linked, i.e. the radical carrying the ionic charge is bonded to the organosilicon radical only by an Si—C bond and not to certain fractions also via an Si—O bond.

The specification family DE-28 26 224 (U.S. Pat. No. 3,849,315 A), WO-A-80/01883, U.S. Pat. No. 4,464,267, U.S. Pat. No. 4,387,032, U.S. Pat. No. 4,060,489, U.S. Pat. No. 4,149,599 and U.S. Pat. No. 4,060,132 teaches fire-extinguishing foams for burning hydrophilic liquids which comprise a polysaccharide and optionally silicones and/or fluorinated hydrocarbons. The fluorinated hydrocarbons can optionally also be omitted, although only their presence makes the formulation, following dilution and foaming, into effective fire extinguishers on hydrophobic liquids such as petrol. The surface-active silicones or the fluorinated hydrocarbons serve there to generate an aqueous film, but themselves do not foam to an adequate degree. Yet further, surface-active substances which are neither fluorinated hydrocarbons nor silicones are required to impart the desired foamability to the compositions. In contrast to the compounds according to the invention, the described silicone surfactants are purely SiC-linked, i.e. the radical carrying the ionic charge is only bonded to the organosilicon compound by an Si—C bond and not to certain fractions also via an Si—O—C bond.

In the context of increasing environmental awareness, however, fluorine-containing compounds have increasingly been the subject of criticism in recent years on account of their extremely low biodegradability and in some instances high residence time in the organism (M. Fricke, U. Lahl, Risk assessment of perfluoro surfactants as contribution to the current discussion to the REACH dossier of the EU Commission, UWSF—Z. Umweltchem. Ökotox. 2005, 17, 36-49). In 2005, Sweden proposed, in the course of the Stockholm Convention on Persistent Organic Pollutants, a world-wide ban for perfluorooctanesulphonates (PFOS)—customary ingredients and starting materials for AFFF. The person skilled in the art can expect that the use of surfactants containing perfluorinated groups will become restricted in the future for reasons of environmental and health protection, and, even if their use were to be exceptionally permitted for extinguishing applications, they will only be available at increased prices due to the reduced production volume. There is therefore a need for foam compositions which are suitable for fighting solvent and fuel fires and which make do without or at least with a significantly reduced fraction of surfactants containing perfluorinated groups.

The application specification WO-A-2004/112907 (U.S. Pat. No. 7,005,082 B2) discloses a foam composition concentrate based on high molecular weight polymers with acidic functionalities in combination with metal salts which does not require organic fluorine compounds. The metal salts described therein include the toxic salts of, for example, antimony, barium, copper, thallium or tin.

It is prior art that organosilicon compounds with sulphate and/or sulphonate groups can form aqueous foams. DE-17 45 514 (U.S. Pat. No. 3,513,183) describes silicone sulphates and their use as wetting agents and emulsifiers. U.S. Pat. No. 4,960,845 describes the use of organosilicon compounds which carry sulphated polyether radicals. Sulphonated polyethers are not mentioned. The use as surfactants for extinguishing fires is likewise not mentioned. U.S. Pat. No. 6,777,521 discloses compounds which carry sulphated groups of the type Si(CH₂)₃—O—CH₂—CH(OH)—CH₂—SO₄⁻ and their use in polyurethane foams and cosmetic formulations. The use as surfactant for generating extinguishing foam for fighting fires is not disclosed. The disclosed compounds exhibit unsatisfactory foaming ability on hydrophobic surfaces.

The laid-open specification DE-16 68 759 (U.S. Pat. No. 3,507,897) describes surface-active compositions based on organosilicon compounds which contain sulphonate groups and their use as foam compositions, emulsifiers and wetting agents. The organosilicon compounds are characterized in that they contain groups of the type —Si(CH₂)₃—O—CH₂—CH(OH)—CH₂—SO₃.

The laid-open specification DE-1 768 252 (U.S. Pat. No. 3,531,417) teaches the preparation of polyether siloxanes containing sulphonate groups and mentions their suitability as foam compositions. The use as surfactant for generating extinguishing foam for fighting fires is not disclosed. The disclosed compounds exhibit unsatisfactory foaming ability on hydrophobic liquids.

It was an object of the present invention to provide alternative compositions for generating foams which do not have one or more disadvantages of the concentrates of the prior art. The foams produced from the compositions should particularly preferably have a high stability on hydrophobic liquids without or with only a small addition of fluorine-containing compounds. Furthermore, the alternative compositions should be easy and cost-effective to produce.

Surprisingly, it has been found that this object is achieved by compositions which have organosilicon compounds containing sulphonate groups and having Si—O—C linkages. Neither improved foaming behaviour of completely or partially Si—O—C-linked sulphonate-group-containing organosilicon compounds, nor the use of these compounds as foam compositions for fighting fire, in particular for fighting fuel fires, without the obligatorily required addition of surfactants containing perfluorinated groups can be deduced or derived from the prior art. The suitability as extinguishing foam is completely unexpected for the person skilled in the art in particular inasmuch as the fact that organosilicon compounds containing sulphonate groups used according to the prior art for extinguishing foam applications always require the presence of surfactants containing perfluorinated groups for generating foams of high stability that can be applied to or on hydrophobic liquids.

The object of the present invention is therefore a composition having organosilicon compounds for generating foams (foam compositions), which is characterized in that the composition comprises one or more organosilicon compounds which comprises
a) at least one siloxane unit of the formula (I)

R¹_{w}(R²O)ₓSiO_{[4-(w+x)]/2} (I),
where
R¹ and R² are one or more identical or different radicals independent of one another and selected from linear or branched, saturated, mono- or polyunsaturated alkyl, haloalkyl, aryl, alkylaryl or arylalkyl radicals having 1 to 30 carbon atoms, where the radicals may optionally be interrupted by one or more oxygen and/or nitrogen atoms and/or may optionally have a —OC(O)CH₃ group on the end of the radical,
w is 0, 1, 2 or 3 and
x is 0, 1, 2 or 3,
where the sum w+x is not >3,
b) optionally one or more siloxane units of the general formula (VI)

R³_{y}R⁴₁SiO_{[4-(y+1)]/2} (VI),
where
R³ is as R¹ defined in a),
y is 0, 1 or 2 and
R⁴ is a group of the formula Aₐ-B_{b}-C_{c}-D_{d}-Eₑ-Lₗ,
where
a is 1,
b, c, d and e are 0 or 1,
l is 1 and
a+b+c≧1, where
A is an oxygen atom, a CH₂ group or a CH═CH group,
B is a group of the general formula (III)

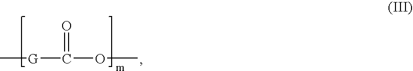

where
m is an integer from 0 to 30 and
G may be a divalent group selected from linear or branched, saturated, mono- or polyunsaturated alkyl, aryl, alkylaryl or arylalkyl groups having 1 to 20 carbon atoms,
C is a CH₂ group or a divalent radical selected from linear or branched, saturated, mono- or polyunsaturated alkyl-, aryl-, alkylaryl- or arylalkyl-oxy groups having 1 to 20 carbon atoms or a group of the formula —CH₂—O—(CH₂)₄—O—,
D is a group of the general formula (IV)

—(C₂H₄O)ₙ(C₃H₆O)ₚ(C₁₂H₂₄O)_{q}(C₈H₈O)ᵣ— (IV),
where
n, p, q and r are integers from 0 to 50 independently of one another, and if more than one of the indices is n, p, q, r>0, the general formula (IV) is a random oligomer or a block oligomer,
E is a group of the general formula (V)

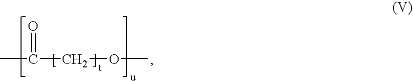

where
u is an integer from 0 to 5 and
t, if u is >0, may be identical or different and is 3, 4 or 5, and
L is selected from the group comprising hydrogen atoms, linear or branched, saturated, mono- or polyunsaturated alkyl, aryl, alkylaryl or arylalkyl groups having 1 to 12 carbon atoms, acetoxy groups, PO₃H₂ groups, PO₃H 1/ᵥM^{v+} groups and PO₃²⁻ 2/ᵥM^{v+} groups where M^{v+} is a v-valent cation where
v is 1, 2, 3 or 4, and
c) at least one siloxane unit of the formula (II) which has at least one sulphonate group,

R⁵_{z}R⁶SiO_{[4-(z+1)]/2} (II),
where
R⁵ is as R¹ defined under a)
z is 0, 1 or 2 and
R⁶ is a group of the formula
Aₐ-B_{b}-C_{c}-D_{d}-Eₑ-F_{f}—SO₃⁻ 1/ᵥM^{v+},
where
a, c and f are 1,
b and e are 0 or 1 and
d in at least 70% of the radicals R⁶=1, where
A, B, C, D, E and M^{v+} can have the meaning as given in b),
F is a divalent radical selected from linear or branched, saturated, mono- or polyunsaturated alkyl, aryl, alkylaryl or arylalkyl groups having 1 to 20 carbon atoms and
M^{v+} is a v-valent cation where v=1, 2, 3 or 4, with the proviso that the radical A in 5 to 100% of the radicals A is an oxygen atom and in 0 to 95% of the radicals A is a CH₂ group and/or a CH═CH group.

The present invention likewise provides the use of a composition according to the invention or of the organosilicon compounds present in the composition according to the invention for producing a foam, in particular an aqueous foam.

The compositions according to the invention have the advantage that the foams obtained from them are also sufficiently stable on hydrophobic and possibly combustible materials, in particular liquids, and can thus also be applied to such materials. As a result, the foams produced from the compositions according to the invention, in particular aqueous foams, are exceptionally suitable as fire-extinguishing foams, covering foams or cleaning foams, in particular for use in the presence of hydrophobic materials, in particular hydrophobic liquids.

The composition according to the invention has, particularly as a result of the stability of the foam produced therefrom without the addition of surfactants containing perfluorinated groups, the advantage that, upon using the foams, no organofluorine compounds pass into the environment.

The compositions according to the invention and a process for their preparation and also their use are described below by way of example, although the invention should not be restricted to these exemplary embodiments. Where ranges, general formulae or compound classes are stated below, then these should include not only the corresponding ranges or groups of compounds which are explicitly mentioned, but also all part ranges and subgroups of compounds which can be obtained by taking out individual values (ranges) or compounds. Where documents are cited in the course of the present description, then their entire content should form part of the disclosure content of the present invention.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

Compositions for generating foams are understood below as meaning compositions which are suitable for forming foam by introducing gas bubbles, in particular by mechanically introducing gas bubbles and very particularly preferably by mixing in gas bubbles, in particular air bubbles, into extinguishing water which comprises the composition according to the invention.

The inventive composition having organosilicon compounds for generating foams (foam compositions) is characterized in that the composition comprises one or more organosilicon compounds which comprises
a) at least one siloxane unit of the formula (I)

R¹_{w}(R²O)ₓSiO_{[4-(w+x)]/2} (I),
where
R¹ and R² are one or more identical or different radicals independent of one another and selected from linear or branched, saturated, mono- or polyunsaturated alkyl, haloalkyl, aryl, alkylaryl or arylalkyl radicals having 1 to 30 carbon atoms, where the radicals may optionally be interrupted by one or more oxygen and/or nitrogen atoms and/or may optionally have a —OC(O)CH₃ group on the end of the radical,
w is 0, 1, 2 or 3 and
x is 0, 1, 2 or 3,
where the sum w+x is not >3,
b) optionally one or more siloxane units of the general formula (VI)

R³_{y}R⁴₁SiO_{[4-(y+1)]/2} (VI),
where
R³ is as R¹ defined in a),
y is 0, 1 or 2 and
R⁴ is a group of the formula Aₐ-B_{b}-C_{c}-D_{d}-Eₑ-Lₗ,
where
a is 1,
b, c, d and e are 0 or 1,
l is 1 and
a+b+c≧1, where
A is an oxygen atom, a CH₂ group or a CH═CH group,
B is a group of the general formula (III)

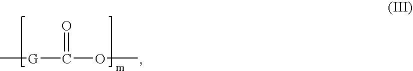

where
m is an integer from 0 to 30 and
G may be a divalent group selected from linear or branched, saturated, mono- or polyunsaturated alkyl, aryl, alkylaryl or arylalkyl groups having 1 to 20 carbon atoms,
C is a CH₂ group or a divalent radical selected from linear or branched, saturated, mono- or polyunsaturated alkyl-, aryl-, alkylaryl- or arylalkyl-oxy groups having 1 to 20 carbon atoms or a group of the formula —CH₂—O—(CH₂)₄—O—,
D is a group of the general formula (IV)

—(C₂H₄O)ₙ(C₃H₆O)ₚ(C₁₂H₂₄O)_{q}(C₈H₈O)ᵣ— (IV),
where
n, p, q and r are integers from 0 to 50 independently of one another, and if more than one of the indices is n, p, q, r>0, the general formula (IV) is a random oligomer or a block oligomer,
E is a group of the general formula (V)

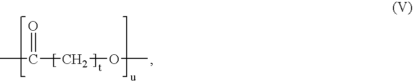

where
u is an integer from 0 to 5 and
t, if u is >0, may be identical or different and is 3, 4 or 5, and
L is selected from the group comprising hydrogen atoms, linear or branched, saturated, mono- or polyunsaturated alkyl, aryl, alkylaryl or arylalkyl groups having 1 to 12 carbon atoms, acetoxy groups, PO₃H₂ groups, PO₃H 1/v M^{v+} groups and PO₃²⁻ 2/v M^{v+} groups where M^{v+} is a v-valent cation where
v is 1, 2, 3 or 4, and
c) at least one siloxane unit of the formula (II) which has at least one sulphonate group,

R⁵_{z}R⁶SiO_{[4-(z+1)]/2} (II),
where
R⁵ is as R¹ defined under a)
z is 0, 1 or 2 and
R⁶ is a group of the formula

Aₐ-B_{b}-C_{c}-D_{d}-Eₑ-F_{f}—SO₃⁻1/ᵥM^{v+},
where
a, c and f are 1,
b and e are 0 or 1 and
d in at least 70% of the radicals R⁶=1, where
A, B, C, D, E and M^{v+} can have the meaning as given in b),
F is a divalent radical selected from linear or branched, saturated, mono- or polyunsaturated alkyl, aryl, alkylaryl or arylalkyl groups having 1 to 20 carbon atoms and
M^{v+} is a v-valent cation where v=1, 2, 3 or 4, with the proviso that the radical A in 5 to 100% of the radicals A is an oxygen atom and in 0 to 95% of the radicals A is a CH₂ group and/or a CH═CH group. Preferably, the radical A in the sum of the siloxane units of the formula (II) and optionally (VI), in particular in formula (II), is an oxygen atom to 7.5 to 75%, preferably to 10 to 50%.

In another embodiment of the invention, in the at least one siloxane unit of the formula (I), at least one of w and x is not zero.

It may be advantageous if the organosilicon compounds having siloxane units of the formulae (I), (II) and optionally (VI) of the compositions according to the invention have, on average, a ratio of the number of silicon atoms to the number of sulphonate groups of from 1.5:1 to 20:1, preferably from 20:1 to 10:1, with preference from 2.2:1 to 4:1.

Preferred compositions according to the invention have organosilicon compounds which have siloxane units of the formula (I) where R¹=CH₃ and x=0, siloxane units of the formula (II) where R¹=CH₃, A=oxygen atom or CH₂ group, m=0, C=CH₂ group or CH₂CH₂O group, n and p=integers from 0 to 30 independent of one another, q=r=u=0, F=CH₂CH₂ group or CH₂CH₂CH₂ group and siloxane units of the formula (VI) where R³=CH₃ and y=1 or 2.

Particularly preferred compositions according to the invention have organosilicon compounds which have siloxane units of the formula (I) where R¹=CH₃ and x=0 and siloxane units of the formula (II) where R⁵=CH₃, z=1 or 2, A=oxygen atom or CH₂ group, m=0, C=CH₂ group or CH₂CH₂O group, n=integer from 0 to 20, p=q=r=u=0 and F=CH₂CH₂ group or CH₂CH₂CH₂ group.

Very particularly preferred compositions according to the invention have organosilicon compounds which have, on average,

0 to 30 mol % of units of the formula (I) where R¹=CH₃ group, w=1, x=0,
0 to 95 mol % of units of the formula (I) where R¹=CH₃ group, w=2, x=0,
0 to 70 mol % of units of the formula (I) where R¹=CH₃ group, w=3, x=0,
10 to 95 mol % of units of the formula (II) where R⁵=CH₃ group, z=1, A-B-C=—CH₂—CH₂—CH₂—O—, n<20, p=q=r=u=0, F=—CH₂—CH₂—CH₂—,
0 to 20 mol % of units of the formula (II) where R⁵=CH₃ group, z=1, A=O and B-C-D-E-F—SO₃⁻ 1/w M^{w+}=—CH₂—CH₂—CH₂—SO₃⁻ 1/w M^{w+},
0 to 20 mol % of units of the formula (II) where R⁵═CH₃ group, z=2, A=O and B-C-D-E-F—SO₃⁻ 1/w M^{w+}=—CH₂—CH₂—CH₂—SO₃⁻ 1/w M^{w+},
0 to 20 mol % of units of the formula (II) where R⁵=CH₃ group, z=3, A=O and B-C-D-E-F—SO₃⁻ 1/w M^{w+}=−CH₂—CH₂—CH₂—SO₃⁻ 1/w M^{w+},
0 to 30 mol % of units of the formula (VI) where R³=CH₃ group, y=1, A-B-C=—CH₂—CH₂—CH₂—O—, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃,
0 to 30 mol % of units of the formula (VI) where R³=CH₃ group, y=1, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃,

0 to 30 mol % of units of the formula (VI) where R³=CH₃ group, y=2, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃, and

0 to 30 mol % of units of the formula (VI) where R³=CH₃ group, y=3, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃.

In the siloxane units, M^{v+} if preferably selected from the cations of the group K⁺, Na⁺, NH₄⁺, (iC₃H₇)NH₃⁺, or (CH₃)₄N⁺ or (CH₃)₂N⁺R⁷R⁸, where R⁷ and R⁸ are identical or different alkyl radicals, in particular those having 1 to 20 carbon atoms, or a mixture thereof. M^{v+} is particularly preferably K⁺ or Na⁺.

The compositions having organosilicon compounds according to the invention for generating foams can have further customary additives. In particular, these may be
a) amphoteric hydrocarbon surfactants, such as, for example, betaines and sulphobetaines, which are commercially available, for example, under the trade names Tego Betain F50 from Goldschmidt, Chembetain CAS (cocoamidopropylbetaine) from Chemron, Mirataine CS (Rhodia), Mackam 2CYSF (McIntyre), Deiphat D-160C (Henkel),
b) anionic hydrocarbon surfactants, such as, for example, alkyl carboxylates, sulphates, -sulphonates and ethoxylated derivatives thereof, in particular octyl and lauryl dipropionates, sodium octyl sulphate, sodium decyl sulphate, sodium dodecyl sulphate or ammonium lauryl ether sulphates,
c) nonionic hydrocarbon surfactants, such as, for example, alkoxylated alkylphenols, linear or branched alcohols and alkoxides thereof, such as, for example, oleyl alcohol ethoxylates, fatty acids and derivatives thereof, alkylamines, alkylamides, acetylene glycols, gemini surfactants, such as, for example Surfynol 104 (AirProducts), alkyl glycosides or polyglycosides, as described in U.S. Pat. No. 5,207,932, or ethylene oxide-propylene oxide block polyethers,
d) polymeric foam stabilizers and/or thickeners, such as, for example, proteins or degradation products thereof, such as, for example, partially hydrolysed proteins, starch, polyvinyl resins, such as, for example, polyvinyl alcohol, polyacrylamides, carboxyvinyl polymers or polypyrrolidines,
e) the combination, disclosed in WO-A-2004/112907 (U.S. Pat. No. 7,005,082 B2), with high molecular weight acidic polymers and coordinating salts,
f) foam auxiliaries, such as, for example, butyl diglycol, glycerol, ethylene glycol monoalkyl ether, diethylene glycol monoalkyl ether, triethylene glycol monoalkyl ether, propylene glycol monoalkyl ether, dipropylene glycol monoalkyl ether, tripropylene glycol monoalkyl ether, 1-butoxyethoxy-2-propanol or hexylene glycol,
g) antifreezes, such as, for example, alkali metal or alkaline earth metal chlorides, urea, glycols or glycerol,
h) additives said to combat flocculation, separation or corrosion, such as, for example, citric acid, tartaric acid, polyaminopolycarboxylic acids, ethylenediamine tetraacetates, o-phenylphenol, phosphate esters or tolyltriazole,
i) film-forming additives, such as, for example, the polysaccharides described in the specification family DE-28 26 224 (U.S. Pat. No. 3,849,315 A), WO-A-80/01883 (U.S. Pat. No. 3,849,315 A), U.S. Pat. No. 4,464,267, U.S. Pat. No. 4,387,032, U.S. Pat. No. 4,060,489, U.S. Pat. No. 4,149,599 and U.S. Pat. No. 4,060,132, or xanthan, pectin, algin, agar, carrageen, pectic acid, starch, modified starch, alginic acid, gum arabic, dextrans, cellulose, hydroxyalkylcelluloses, cellulose ethers and esters or the like,
j) preservatives, as are commercially available, for example, under the names Kathon CG/ICP (Rohm & Haas) or Givgard G-4-40 (Givaudan),
k) water, such as, for example, fresh water, drinking water, surface water, salt water, sea water or brackish water, or
l) additives which are obvious to the person skilled in the art and are not further detailed here.

The compositions according to the invention can be used for producing a foam, preferably an aqueous foam. The compositions according to the invention can be used in particular for producing fire-extinguishing foams, exercise foams or foams for the cleaning of installations or apparatuses, such as, for example, oil depots, pipes, pipelines or drums, for reducing evaporative losses of volatile hydrocarbons or other organic solvents, and for preventing the break-out of fires.

If a composition according to the invention is used for producing fire-extinguishing foams, it may be advantageous if surfactants containing perfluorinated groups, for example those as described in the U.S. Pat. Nos. 4,060,489, 4,420,434, 4,472,286, 4,999,119, 5,085,786, 5,218,021 or 5,616,273, are/have been also added to the composition.

The amounts of surfactant containing perfluorinated groups are preferably chosen such that without the organosilicon compounds according to the invention, no extinguishing foam corresponding to the prior art could be obtained at the stated concentration of surfactant containing perfluorinated groups. In this way, an extinguishing foam can be obtained which, upon use, has a further improved extinguishing rate and a reduced risk of reignition. It has been found that the total content of surfactants containing perfluorinated groups may be equal to or less than half of the concentration of surfactants containing perfluorinated groups required for generating a comparable extinguishing foam (extinguishing foam with comparable extinguishing and stability properties) without detectable amounts of organosilicon compounds which have units according to formulae (I) and (II), as defined above.

Starting from the teaching of U.S. Pat. No. 5,207,932, a composition according to the invention therefore preferably has less than 0.20% by weight of organically bonded fluorine, based on the composition.

The compositions according to the invention can be diluted to customary concentrations. Typical foam concentrates have, for example, 1 to 10 parts by mass, preferably 2 to 6 parts by mass and particularly preferably 3 or 6 parts by mass of the composition according to the invention and 99 to 90, preferably 98 to 95 and particularly preferably 97 to 96 parts by mass of extinguishing water, which may be, for example, fresh water, drinking water, surface water, salt water, sea water or brackish water. A 3% strength by weight foam concentrate thus gives rise, at a concentration of 0.2% by weight of surfactants containing perfluorinated groups, to a concentration of surfactants containing perfluorinated groups in the extinguishing foam of about 0.006% by weight. The teaching according to the prior art as can be found, for example, in the above-mentioned specifications U.S. Pat. No. 3,849,315, U.S. Pat. No. 4,038,195, U.S. Pat. No. 3,957,657 and U.S. Pat. No. 3,957,658, and also the specifications of the specification family DE-A-28 26 224 (U.S. Pat. No. 3,849,315 A), WO-A-80/01883 (U.S. Pat. No. 3,849,315 A), U.S. Pat. No. 4,464,267, U.S. Pat. No. 4,387,032, U.S. Pat. No. 4,060,489, U.S. Pat. No. 4,149,599 and U.S. Pat. No. 4,060,132, requires a five-fold to ten-fold concentration of surfactants containing perfluorinated groups.

The compositions according to the invention can be prepared in highly diverse ways and in various concentrations. In particular, they can be prepared by mixing. Preference is given to compositions according to the invention which are prepared by mixing the organosilicon compounds which have units of the formulae (I) and (II) as defined above with amphoteric hydrocarbon surfactants, anionic hydrocarbon surfactants, nonionic hydrocarbon surfactants, polymeric foam stabilizers and/or thickeners, high molecular weight acidic polymers and/or coordinating salts, foam auxiliaries, antifreezes, additives to combat flocculation, corrosion or separation, film-forming additives, preservatives, water and additives which are obvious to the person skilled in the art in the concentrations which the specifications listed in this application teach.

The organosilicon compounds present in the compositions according to the invention can be prepared in various ways. For example, the organosilicon compounds which have a siloxane unit of the formula (II) can be obtained by addition of hydrogen siloxanes onto alkenyl polyether sulphonates (hydrosilylation) or by dehydrogenative condensation of units carrying silane hydrogen with present polyether sulphonates containing hydroxy groups.

The hydrosilylation of the sulphonates of alkenyl polyethers is preferably carried out in the presence of a precious metal catalyst, in particular a rhodium or platinum catalyst. Preference is given to using the catalyst in an amount of from 5 to 20 mass ppm of a platinum or rhodium catalyst (mass fraction of precious metal based on the mass of the total mixture). The catalyst is particularly preferably used in the form of hexachloroplatinic acid, cis-platinum, di-μ-chlorobis-[chloro(cyclohexene)platinum(II)] or Karstedt catalyst (optionally dissolved in solvents), or in the form of finely divided elemental platinum on a carrier material such as aluminium oxide, silica gel or active carbon. The hydrosilylation is preferably carried out at a temperature of from 60 to 200° C., preferably from 70 to 130° C. Preferably, the hydrosilylation is carried out at a pressure of from 0.9 to 20 bar, preferably at 0.980 to 2 bar. It may be advantageous if the hydrosilylation is carried out in a solvent. Preference is given to using inert solvents, such as, for example, xylene or toluene. Solvents that can be used, however, are also alcohols, such as, for example, 2-butoxyethanol, butyl glycol, butyl diglycol, isopropanol, ethylene glycol or 1,2-propanediol, ethers, such as, for example, di(propylene glycol) butyl ether or di(propylene glycol) methyl ether, polyethers, such as, for example, allyl-, methyl- or butyl-started polyethers or water.

Organosilicon compounds in which A in the units of the formula (VI) and (II) is oxygen can, however, also be obtained by dehydrogenative condensation of hydroxy-group-terminated sulphonated polyethers with hydrogen siloxanes. Preferably, the dehydrogenative condensation is carried out in the presence of a catalyst. Suitable catalysts for the dehydrogenative condensation are, for example, NaOH, KOH, tetramethylammonium hydroxide, alkali metal fluorides, alkaline earth metal fluorides, boron catalysts, such as tris(pentafluorophenyl)borane, carboxylic acids and/or carboxylates or mixtures thereof. The catalytic dehydrogenative condensation is described, for example, in the specifications EP-A-1 460 098 (U.S. Pat. No. 7,053,166 B2, US-A 2004/186259 A1), DE-A-103 12 636 (US-2004/186260 A1) and DE-A-103 59 764 (US-2005/136269 A1), in the published application specification DE 10 2005 051 939.3 (US-2007/100153 A1), and in the Japanese Patent Publication JP 48-19941, to which U.S. Pat. No. 5,147,965 refers. Reference is expressly made to the content of said specifications and the content of said specifications forms part of the disclosure of the present application.

A further possibility for providing organosilicon compounds which have units according to formula (II) in which A is oxygen consists, for example, in adding compounds of the formula HSO₃⁻ 1/v M^{v+} (see above for the meaning of M) onto the double bond in allyl alcohol-started polyethers with OH terminus. Such an addition is described, for example, in DE-C-36 33 421 (U.S. Pat. No. 4,927,961 A). Alternatively, polyethers with one sulphonate terminus and one OH terminus can be prepared in the manner described in the specification U.S. Pat. No. 3,823,185. Such OH-terminated polyethers can then, as described above, be reacted by dehydrogenative condensation with hydrogen siloxanes. It is likewise possible to firstly condense allyl alcohol started polyethers dehydrogenatively with hydrogen siloxanes and to add compounds of the formula HSO₃⁻/v M^{v+} to the double bond of the allyl group.

It is also possible to react hydrogen siloxanes with sulphonate-group-containing and non-sulphonate-modified polyethers simultaneously or in any desired order.

Furthermore, it is possible to add compounds of the formula HSO₃⁻ 1/v M^{v+} only partially to polyethers with two alkenyl double bonds and to hydrosilylate the remaining double bonds with hydrogen siloxanes.

The sulphonate-group-carrying polyether used can be, for example, RALU®MER SPPE from Raschig. This can be prepared as described, for example, in laid-open specification DE-1 768 252 (U.S. Pat. No. 3,531,417). Preferably, the polyether is prepared analogously to Example 1 of the laid-open specification DE-1 768 252 (U.S. Pat. No. 3,531,417) in the way known to the person skilled in the art. However, neutralization is particularly preferably not carried out as in Example 1 of the laid-open specification DE-1 768 252 (U.S. Pat. No. 3,531,417) with concentrated hydrochloric acid, but with hydroxypropanesulphonic acid, which can find its way into the subsequent reaction with the hydrogen siloxane. The reaction of the allyl polyether with the propane sultone can take place in equimolar amounts or else using an excess of allyl polyether or of propane sultone. If an excess of allyl polyethers is used, then the resulting mixture can be used directly in the hydrosilylation. To destroy any propane sultone residues that may be present, suitable additives, such as, for example, alcohols, alkoxides and/or amines, can be used.

The present invention is described by way of example in the examples given below, although the invention, the breadth of application of which arises from the overall description and the claims, is not intended to be restricted to the embodiments given in the examples.

### EXAMPLES 1 TO 4

### Preparation of Organosilicon Compounds which have Si—O—C Bond Fractions

### Drying of an Anionic Polyether:

Unless mentioned otherwise, the product RALU®MER SPPE from Raschig (polyethylene glycol allyl (3-sulphopropyl) diether potassium salt) was dried before the following reactions by azeotropic distillation with toluene. Here, an approximately 70% strength by weight solution of the anionic polyether in toluene was obtained. The polyether content was determined via the iodine number known to the person skilled in the art. To destroy propane sultone residues, further additives can be used in the azeotropic distillation, such as, for example, alcohols, alkoxides and/or amines.

### EXAMPLE 1

### Preparation by Hydrosilylation

70.8 g of the approximately 70% strength by weight solution of the anionic polyether in toluene obtained from the drying described above were initially introduced into a 250 ml three-neck flask equipped with a stirrer, a high-performance condenser, a mushroom heating hood, a thermometer and a dropping funnel, and heated to 50° C., and Karstedt catalyst (platinum-divinyltetramethyldisiloxane complex from ABCR) was added such that platinum was present in the mixture in a concentration of 5 ppm based on the total mixture weight. At 50° C., 15.0 g of 1,1,1,3,5,5,5-heptamethyltrisiloxane (Gelest) were added. Further Karstedt catalyst (10 ppm by mass of platinum based on the total mixture weight) was then added and the mixture was stirred for a further 3 h at 60 to 70° C. After removing the solvent under reduced pressure (membrane pump vacuum), a pale yellow, waxy-like solid was obtained whose ²⁹Si-NMR spectrum (created using Bruker AVANCE 400 NMR spectrometer with evaluation software XWIN-NMR 3.1 and tetramethylsilane as internal standard) revealed, inter alia, signals of the chemical shifts of 19 ppm (units of the formula II where R=CH₃, c=3, R¹=O—CH₂—CH₂—CH₂—SO₃Na; signal intensity 17% of the (CH₃)₃SiO signals), −11 to −12 ppm (units of the formula II where R=CH₃, c=2, R¹=O—CH₂—CH₂—CH₂—SO₃Na; signal intensity 28% of the (CH₃)₃SiO signals), −55 to −59 ppm (units of the formula II where R=CH₃, c=1, R¹=O—CH₂—CH₂—CH₂—SO₃Na; signal intensity 22% of the (CH₃)₃SiO signals) and −63 to −71 ppm (units of the formula I where R=CH₃, a=1, b=0; signal intensity 35% of the (CH₃)₃SiO signals).

### EXAMPLE 2

### Preparation by Hydrosilylation

623 g of the approximately 70% strength by weight solution of the anionic polyether in toluene obtained from the drying described above were initially introduced into a 1 1 three-neck flask equipped with a stirrer, a high-performance condenser, a mushroom heating hood, a thermometer and a dropping funnel, and heated to 70° C., and Karstedt catalyst (16 ppm of platinum based on the total mixture weight) was added. At 70° C., 125 g of 1,1,1,3,5,5,5-heptamethyltrisiloxane were added. The mixture was then diluted with 47 g of toluene and stirred for a further 2 h at 70° C. 39.7 g of butyl diglycol (diethylene glycol monobutyl ether ≧99%, Aldrich) were added to 301 g of the resulting reaction mixture, and the solvent toluene was removed under reduced pressure (membrane pump vacuum). This gave a pale brown, viscous, flowable product whose ²⁹Si-NMR spectrum (recorded as described in Example 1) exhibits, inter alia, signals of the chemical shifts of 19 ppm (units of the formula II where R=CH₃, c=3, R¹=O—CH₂—CH₂—CH₂—SO₃Na; signal intensity 11% of the (CH₃)₃SiO signals), −11 to −12 ppm (units of the formula II where R=CH₃, c=2, R¹=O—CH₂—CH₂—CH₂—SO₃Na; signal intensity 15% of the (CH₃)₃SiO signals), −55 to −59 ppm (units of the formula II where R=CH₃, c=1, R¹=O—CH₂—CH₂—CH₂—SO₃Na; signal intensity 19% of the (CH₃)₃SiO signals) and −64 to −69 ppm (units of the formula I where R=CH₃, a=1, b=0; signal intensity 20% of the (CH₃)₃SiO signals).

### EXAMPLE 3

### Preparation by Hydrosilylation

105 g of undried RALU®MER SPPE and 16.8 g of an allyl alcohol-started polyethylene glycol of average molar mass 400 g/mol were initially introduced into a 500 ml three-neck flask equipped with a stirrer, a high-performance condenser, a mushroom heating hood, a thermometer and a dropping funnel, and heated to 70° C., and Karstedt catalyst (6 ppm by mass of platinum based on the total mixture weight) was added. At 70° C., 52 g of (CH₃)₃SiO—(Si(CH₃)₂O)₂₁—(HSiCH₃O)₅—OSi (CH₃)₃ (product of Goldschmidt GmbH) were added dropwise. The mixture was then stirred for 2 h at 70° C., further Karstedt catalyst (6 ppm by mass of platinum based on the total mixture weight) was added and the mixture was stirred for a further 7 h at 70° C. A pale yellow, viscous product was obtained whose ²⁹Si-NMR spectrum (obtained as described in Example 1) exhibits, inter alia, signals of the chemical shifts from −20 to −23 ppm (units of the formula I where R=CH₃, a=2, b=0; units of the formula II where R=CH₃, c=1, A=CH₂ group, m=p=q=r=u=0, C=CH₂CH₂O, n>0, F=CH₂CH₂CH₂; units of the formula VI where R=CH₃, x=1, y=1, A=CH₂ group, m=p=q=r=u=0, C=CH₂CH₂O, n>0, L=H atom; signal intensity 18 times intensity of the (CH₃)₃SiO signals) and −58 to −61 ppm (units of the formula VI where R=CH₃, x=1, y=1, A=O atom, m=p=q=r=u=0, C=CH₂CH₂O, n>0, L=CH2-CH═CH2 group; units of the formula II where R=CH₃, c=1, R¹=O—CH₂—CH₂—CH₂—SO₃Na; signal intensity 56% of the (CH₃)₃SiO signals).

### EXAMPLE 4

### Preparation by Dehydrogenative Condensation

In a 500 ml three-neck flask equipped with a stirrer, a high-performance condenser, a mushroom heating hood, a thermometer and a dropping funnel, 110 g of a 70.1% strength by weight solution of an anionic polyether of the formula HO—(CH₂CH₂O)ₙ—CH₂CH₂SO₃Na with an average molar mass of 380 g/mol, prepared according to the process described in the patent specification U.S. Pat. No. 3,823,185, were heated to 120° C., and 2.5 mol %, based on the polyether, of a 1:1 mixture (molar ratio) of lauric acid and caesium laurate were added. At 120° C., 40.7 g of 1,1,1,3,3,5,5-heptamethyltrisiloxane were added dropwise. The mixture was then stirred for 3 h at 120° C., and the solvent toluene was removed under reduced pressure (membrane pump vacuum). A pale yellow, waxy-like product was obtained whose ²⁹Si-NMR spectrum (recorded as described in Example 1) exhibits, inter alia, signals of the chemical shifts from −10 to −12 ppm (units of the formula II where R=CH₃, c=2, A=O atom, m=p=q=r=u=0, n>0, F=CH₂CH₂; signal intensity 110% of the (CH₃)₃SiO signals).

### EXAMPLES 5 TO 10

### Examples for Using the Organosilicon Compounds Having Si—O—C Bond Fractions

The ability of the compounds according to the invention to generate aqueous foams was tested by ascertaining the foaming number. The foaming number is the ratio of the volume of the finished foam to the volume of the water/foam composition mixture. A detailed description of this parameter can be found, for example, in G. Rodewald, A. Rempe: “Feuerlöschmittel. Eigenschaften—Wirkung—Anwendung” [Fire-extinguishing compositions. Properties—effect—application]; Kohlhammer Verlag, Stuttgart, 2005. For carrying out the test, the Power Blend MX 2050 stirrer from Braun was used. 100 ml of a solution of 0.45% by mass of the surfactant to be foamed and 1.0% by mass of the foam auxiliary butyl diglycol in tap water of about 10° German hardness were foamed for 30 s and the volume of the foam formed was ascertained in a measuring cylinder. The results obtained are summarized in Table 1, the half-value time (HVT 1) being understood as meaning the time which elapses until half of the liquid has reformed. Furthermore, fresh foam generated in this way was used for extinguishing n-heptane fires in accordance with the general method described, for example, in the laid-open specification DE-1 812 531. It is known to the person skilled in the art that n-heptane is used as a defined model substance for engine fuel, in particular for petrol. For this, analogously to the laid-open specification DE-2 240 263, a metal funnel with a funnel opening of 18 mm was arranged over a metal dish with a diameter of 16 cm which contained 100 g of n-heptane. The n-heptane was ignited and, after a preburning time of 20 s, the extinguishing was started by pouring the foam generated directly beforehand into the funnel. The results are shown in Table 1, where in each case the time in seconds until complete extinction is given.

TABLE 1
Parameters of the examples for the use

| | Formulation in water | | | | | |
|---|---|---|---|---|---|---|
| | Organo-silicon | | Foam properties | | | According to |
| | compound (OSC) | Butyl | Foaming | HVT 1 | Extinction | the |
| Ex. | (0.45% by wt.) | di-glycol % | number | (min) | time (s) | invention |
| 5 | from Ex. 1 | 1 | 3.7 | 5.1 | 15 | yes |
| 6 | from Ex. 2 | 1 | 3.5 | 5 | 17 | yes |
| 7 | from Ex. 3 | 1 | 2.8 | 4 | 22 | yes |
| 8 | from Ex. 4 | 1 | 3.0 | 4.3 | 26 | yes |
| 9 | Texapon NSO | 1 | 6.0 | 6.5 | 34 | no |
| 10 | 80% by wt. | 1 | 5.5 | 7 | 12 | yes |
| | from Ex. 1 + 20% | | | | | |
| | by wt. Texapon NSO | | | | | |

Texapon NSO is a 27% strength by weight aqueous sodium lauryl ether sulphate solution [C₁₂H₂₅—O—[(CH₂)ₛ—O]ᵥ—SO₃]Na from Cognis.

With foaming numbers in the deliberately simply selected formulations in the range from 3 to 4 and half-value times in the range from 4 to 5 min, the compounds according to the invention are suitable as foam compositions (Examples 5 to 8).

It is evident from Examples 5 to 10 that the foams obtained from the compounds according to the invention are suitable for extinguishing fuels. In particular, the formulations containing Examples 1 and 2 (Examples 5 and 6) are significantly superior to formulations containing non-siliconic surfactants (Example 9).

### EXAMPLES 11 TO 13

### Examples for Foam Stability

The stability of the aqueous foams generated from the compounds according to the invention on hydrophobic liquids, as are encountered in installations such as oil depots, pipes, pipelines or drums, when reducing evaporative losses of volatile hydrocarbons or other organic solvents, and when preventing the break-out of fires, was tested on n-heptane. For this, 15 ml of n-heptane were initially introduced into a Petri dish (12×1 cm) and covered with foam which was obtained from in each case 7.5 g of a 1% strength aqueous solution by foaming in an Elegant Foamer Line M3 foam dispenser from Rexam Airspray. The time taken for the originally placed foam surface to half was measured (HVT 2). The results obtained are summarized in Table 2.

TABLE 2
Foam behaviour on n-heptane

| | Organosilicon | | |
|---|---|---|---|
| | compound (1.0% by | | According to |
| Example | wt.) | HVT 2 (min) | the invention |
| 11 | from Example 1 | 19 | yes |
| 12 | from Example 4 | 15 | yes |
| 13 | from Texapon NSO | 7 | no |

The results in Table 2 show that the compounds according to the invention produce significantly more stable foams on n-heptane than organic surfactants which are not organosilicon compounds (Example 13), and are thus suitable for generating aqueous foams at/on hydrophobic liquids as are encountered in installations such as oil depots, pipes, pipelines or drums, when reducing evaporative losses of volatile hydrocarbons or other organic solvents and when preventing the break-out of fires.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. Composition having organosilicon compounds for generating foams, characterized in that the composition comprises one or more organosilicon compounds which comprises
a) at least one siloxane unit of the formula (I)
R¹_{w}(R²O)ₓSiO_{[4-(w+x)]/2} (I),
where
R¹ and R² are one or more identical or different radicals independent of one another and selected from linear or branched, saturated, mono- or polyunsaturated alkyl, haloalkyl, aryl, alkylaryl or arylalkyl radicals having 1 to 30 carbon atoms, where the radicals may optionally be interrupted by one or more oxygen and/or nitrogen atoms and/or may optionally have a —OC(O)CH₃ group on the end of the radical,
w is 0, 1, 2 or 3 and
x is 0, 1, 2 or 3,
where the sum w+x is not greater than 3,
b) optionally one or more siloxane units of the general formula (VI)
R³_{y}R⁴₁SiO_{[4-(y+1)]/2} (VI),
where
R³ is as R¹ defined in a),
y is 0, 1 or 2 and
R⁴ is a group of the formula Aₐ-B_{b}-C_{c}-D_{d}-Eₑ-Lₗ,
where
a is 1,
b, c, d and e are 0 or 1,
l is 1 and
a+b+c≧1, where
A is an oxygen atom, a CH₂ group or a CH═CH group,
B is a group of the general formula (III) 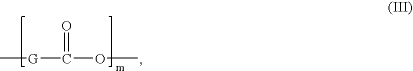
where
m is an integer from 0 to 30 and
G may be a divalent group selected from linear or branched, saturated, mono- or polyunsaturated alkyl, aryl, alkylaryl or arylalkyl groups having 1 to 20 carbon atoms,
C is a CH₂ group or a divalent radical selected from linear or branched, saturated, mono- or polyunsaturated alkyl-, aryl-, alkylaryl- or arylalkyl-oxy groups having 1 to 20 carbon atoms or a group of the formula —CH₂—O— (CH₂)₄—O—,
D is a group of the general formula (IV)
—(C₂H₄O)ₙ(C₃H₆O)ₚ(C₁₂H₂₄O)_{q}(C₈H₈O)ᵣ— (IV),
where
n, p, q and r are integers from 0 to 50 independently of one another, and if more than one of the indices is n, p, q, r>0, the general formula (IV) is a random oligomer or a block oligomer,
E is a group of the general formula (V) 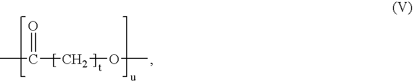
where
u is an integer from 0 to 5 and
t if u is >0, may be identical or different and is 3, 4 or 5, and
L is selected from the group comprising hydrogen atoms, linear or branched, saturated, mono- or polyunsaturated alkyl, aryl, alkylaryl or arylalkyl groups having 1 to 12 carbon atoms, acetoxy groups, PO₃H₂ groups, PO₃H 1/ᵥM^{v+} groups and PO₃²⁻ 2/ᵥM^{v+} groups where M^{v+} is a v-valent cation where
v is 1, 2, 3 or 4, and
c) at least one siloxane unit of the formula (II) which has at least one sulphonate group,
R⁵_{z}R⁶SiO_{[4-(z+1)]/2} (II),
where
R⁵ is as R¹ defined under a)
z is 0, 1 or 2 and
R⁶ is a group of the formula
Aₐ-B_{b}-C_{c}-D_{d}-Eₑ-F_{f}—SO₃⁻1/ᵥM^{v+},
where
a, c and f are 1,
b and e are 0 or 1 and
d in at least 70% of the radicals R⁶=1, where
A, B, C, D, E and M^{v+} can have the meaning as given in b),
F is a divalent radical selected from linear or branched, saturated, mono- or polyunsaturated alkyl, aryl, alkylaryl or arylalkyl groups having 1 to 20 carbon atoms and
M^{v+} is a v-valent cation where v=1, 2, 3 or 4, with the proviso that the radical A in 5 to 100% of the radicals A is an oxygen atom and in 0 to 95% of the radicals A is a CH₂ group and/or a CH═CH group.

2. Composition according to claim 1, characterized in that the organosilicon compounds having siloxane units of the formulae (I), (II) and optionally (VI) have, on average, a ratio of the number of silicon atoms to the number of sulphonate groups of from 1.5:1 to 20:1.

3. Composition according to claim 2, characterized in that the organosilicon compounds have siloxane units of the formula (I) where R¹=CH₃ and x=0 and siloxane units of the formula (II) where R⁵=CH₃, z=1, 2 or 3, A=oxygen atom or CH₂ group, m=0, C=CH₂ group or CH₂CH₂O group, n=integer from 0 to 20, p=q=r=u=0 and F=CH₂CH₂ group or CH₂CH₂CH₂ group.

4. Composition according to claim 2, characterized in that the organosilicon compounds have siloxane units of the formula (I) where R¹=CH₃ and x=0, siloxane units of the formula (II) where R¹=CH₃, A=oxygen atom or CH₂ group, m=0, C=CH₂ group or CH₂CH₂O group, n and p=integers from 0 to 30 independently of one another, q=r=u=0, F=CH₂CH₂ group or CH₂CH₂CH₂ group and siloxane units of the formula (VI) where R³=CH₃ and y=1 or 2.

5. Composition according to claim 2, characterized in that the organosilicon compounds have, on average,
0 to 30 mol % of units of the formula (I) where R¹=CH₃ group, w=1, x=0,
0 to 95 mol % of units of the formula (I) where R¹=CH₃ group, w=2, x=0,
0 to 70 mol % of units of the formula (I) where R¹=CH₃ group, w=3, x=0,
0 to 95 mol % of units of the formula (II) where R⁵=CH₃ group, z=1, A-B-C=—CH₂—CH₂—CH₂—O—, n<20, p=q=r=u=0, F=—CH₂—CH₂—CH₂—,
0 to 20 mol % of units of the formula (II) where R⁵=CH₃ group, z=1, A=O and B-C-D-E-F—SO₃ 1/w M^{w+}=—CH₂—CH₂—CH₂—SO₃ 1/w M^{w+},
0 to 20 mol % of units of the formula (II) where R⁵=CH₃ group, z=2, A=O and B-C-D-E-F—SO₃⁻ 1/w M^{w+}=—CH₂—CH₂—CH₂—SO₃⁻ 1/w M^{w+},
0 to 20 mol % of units of the formula (II) where R⁵=CH₃ group, z=3, A=O and B-C-D-E-F—SO₃⁻ 1/w M^{w+}=—CH₂—CH₂—CH₂—SO₃ 1/w M^{w+},
0 to 30 mol % of units of the formula (VI) where R³=CH₃ group, y=1, A-B-C=—CH₂—CH₂—CH₂—O—, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃,
0 to 30 mol % of units of the formula (VI) where R³=CH₃ group, y=1, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃,
0 to 30 mol % of units of the formula (VI) where R³=CH₃ group, y=2, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃, and
0 to 30 mol % of units of the formula (VI) where R³=CH₃ group, y=3, A=O, m=q=r=t=u=0, n+p<50, C=—CH₂CH₂O— or —CH(CH₃)CH₂O— and L is identical or different and selected from the group consisting of —CH₃, —(CH₂)₂CH₃, —(CH₂)₃CH₃, —(CH₂)₄CH₃, —(CH₂)₅CH₃, —CH₂—CH═CH₂ and —CH═CH—CH₃.

6. Composition according to claim 2, characterized in that A in the sum of the siloxane units of the formula (II) and optionally (VI) is oxygen to 7.5 to 75%.

7. Composition according to claim 3, characterized in that A in the sum of the siloxane units of the formula (II) and optionally (VI) is oxygen to 7.5 to 75%.

8. Composition according to claim 4, characterized in that A in the sum of the siloxane units of the formula (II) and optionally (VI) is oxygen to 7.5 to 75%.

9. Composition according to claim 5, characterized in that A in the sum of the siloxane units of the formula (II) and optionally (VI) is oxygen to 7.5 to 75%.

10. Composition according to claim 1, characterized in that at least one of w and x is not zero.

11. Composition according to claim 2, characterized in that at least one of w and x is not zero.

12. Composition according to claim 11, characterized in that A in the sum of the siloxane units of the formula (II) and optionally (VI) is oxygen to 7.5 to 75%.

13. A method of producing an aqueous foam which comprises of mixing
a) at least one siloxane unit of the formula (I)
R¹_{w}(R²O)ₓSiO_{[4-(w+x)]/2} (I),
where
R¹ and R² are one or more identical or different radicals independent of one another and selected from linear or branched, saturated, mono- or polyunsaturated alkyl, haloalkyl, aryl, alkylaryl or arylalkyl radicals having 1 to 30 carbon atoms, where the radicals may optionally be interrupted by one or more oxygen and/or nitrogen atoms and/or may optionally have a —OC(O)CH₃ group on the end of the radical,
w is 0, 1, 2 or 3 and
x is 0, 1, 2 or 3,
where the sum w+x is not greater than 3,
and
b) optionally one or more siloxane units of the general formula (VI)
R³_{y}R⁴₁SiO_{[4-(y+1)]/2} (VI),
where
R³ is as R¹ defined in a),
y is 0, 1 or 2 and
R⁴ is a group of the formula Aₐ-B_{b}-C_{c}-D_{d}-Eₑ-Lₗ,
where
a is 1,
b, c, d and e are 0 or 1,
l is 1 and
a+b+c≧1, where
A is an oxygen atom, a CH₂ group or a CH═CH group,
B is a group of the general formula (III) 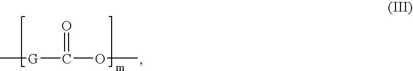
where
m is an integer from 0 to 30 and
G may be a divalent group selected from linear or branched, saturated, mono- or polyunsaturated alkyl, aryl, alkylaryl or arylalkyl groups having 1 to 20 carbon atoms,
C is a CH₂ group or a divalent radical selected from linear or branched, saturated, mono- or polyunsaturated alkyl-, aryl-, alkylaryl- or arylalkyl-oxy groups having 1 to 20 carbon atoms or a group of the formula —CH₂—O— (CH₂)₄—O—,
D is a group of the general formula (IV)
—(C₂H₄O)ₙ(C₃H₆O)ₚ(C₁₂H₂₄O)_{q}(C₈H₈O)ᵣ— (IV),
where
n, p, q and r are integers from 0 to 50 independently of one another, and if more than one of the indices is n, p, q, r>0, the general formula (IV) is a random oligomer or a block oligomer,
E is a group of the general formula (V) 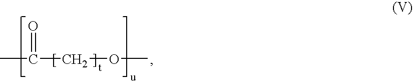
where
u is an integer from 0 to 5 and
t if u is >0, may be identical or different and is 3, 4 or 5, and
L is selected from the group comprising hydrogen atoms, linear or branched, saturated, mono- or polyunsaturated alkyl, aryl, alkylaryl or arylalkyl groups having 1 to 12 carbon atoms, acetoxy groups, PO₃H₂ groups, PO₃H 1/ᵥM^{v+} groups and PO₃²⁻ 2/ᵥM^{v+} groups where M^{v+} is a v-valent cation where
v is 1, 2, 3 or 4,
with
c) at least one siloxane unit of the formula (II) which has at least one sulphonate group,
R⁵_{z}R⁶SiO_{[4-(z+1)]/2} (II),
where
R⁵ is as R¹ defined under a)
z is 0, 1 or 2 and
R⁶ is a group of the formula
Aₐ-B_{b}-C_{c}-D_{d}-Eₑ-F_{f}—SO₃⁻1/ᵥM^{v+},
where
a, c and f are 1,
b and e are 0 or 1 and
d in at least 70% of the radicals R⁶=1, where
A, B, C, D, E and M^{v+} can have the meaning as given in b),
F is a divalent radical selected from linear or branched, saturated, mono- or polyunsaturated alkyl, aryl, alkylaryl or arylalkyl groups having 1 to 20 carbon atoms and
M^{v+} is a v-valent cation where v=1, 2, 3 or 4, with the proviso that the radical A in 5 to 100% of the radicals A is an oxygen atom and in 0 to 95% of the radicals A is a CH₂ group and/or a CH═CH group.

14. The method of claim 13 wherein the foam is a fire extinguishing foam or exercise foam.

15. The method of claim 14 characterized in that surfactants with perfluorinated groups are added to the mixture of a), c) and optionally b), where the total content of surfactants with perfluorinated groups is equal to or less than half of the concentration of surfactants with perfluorinated groups required for generating an extinguishing foam without detectable amounts of organosilicon compounds which have units according to formula (II).

16. The method of claim 13 wherein the foam for cleaning installations or apparatuses, for reducing evaporative losses and for preventing the break-out of fires is produced.
